(19) United States
(12) Patent Application Publication
(10) Pub. No.: US 2024/0026979 A1
(43) Pub. Date: Jan. 25, 2024

(54) VACUUM VALVE FOR A VACUUM CONVEYING SYSTEM

(71) Applicant: VAT HOLDING AG, Haag (CH)

(72) Inventors: Hanspeter FREHNER, Sevelen (CH); Martin NETZER, Bludenz (AT); Pascal Manuel FINKER, Rüthi (CH); Aurel NEFF, Appenzell (CH); Doré DE MORSIER, Zürich (CH)

(21) Appl. No.: 18/256,531

(22) PCT Filed: Dec. 3, 2021
(86) PCT No.: PCT/EP2021/084180

§ 371 Date: Jun. 8, 2023

(30) Foreign Application Priority Data
Dec. 9, 2020 (DE) 10 2020 007 531.2

(51) Int. Cl. F16K 3/02; F16K 3/18; F16K 51/02

(52) U.S. Cl. CPC F16K 3/0245; F16K 3/188; F16K 51/02

(57) ABSTRACT

The invention relates to a vacuum valve for substantially gas-tight closure of a first valve opening including a valve seat, a closure element for substantially gas-tight closure of the first valve opening, and a drive unit for providing a movement of the closure element relative to the valve seat. The closure element is designed to be flexible in such a way that a spatial expansion of the closure element in the closed position is variable in a direction parallel to the opening axis as a function of an applied differential pressure.

The invention relates to a vacuum valve system for substantially gas-tight closure of an opening or volume for a vacuum transport system.

In general, vacuum valves for the substantially gas-tight closure of a flow path or jet path leading through an opening formed in a valve housing are known in various embodiments from the prior art. Vacuum valves are used in particular in the field of IC and semiconductor manufacturing but also, for example, in the field of electron microscopy, which must also take place in a protected atmosphere as far as possible without the presence of contaminating particles.

For example, in a production system for semiconductor wafers or liquid crystal substrates, the highly sensitive semiconductor or liquid crystal elements pass sequentially through several process chambers in which the semiconductor elements located within the process chamber are processed by means of a processing device in each case. Both during the processing process within the process chamber and during transport from process chamber to process chamber, the highly sensitive semiconductor elements must always be in a protected atmosphere, in particular in a vacuum. In addition, vacuum valves are also used in the field of battery production, wherein atmospheric separation of a process area from an ambient atmosphere is also provided. The process chambers are connected to each other, for example, via connecting passages, wherein the process chambers can be opened by means of so-called vacuum slide valves for transferring the parts from one process chamber to the next and subsequently closed in a gas-tight manner for carrying out the respective manufacturing step. Such valves are also referred to as vacuum transfer valves due to the field of application described.

In a specific vacuum or high vacuum application, in which relatively large workpieces are to be processed, the closure element can be much larger than is necessary, for example, for closing a vacuum chamber of an electron microscope. For this purpose, the closure must be designed in such a way that large parts can also be inserted into the vacuum chamber. In particular, the closure element can be designed in the form of a door or gate. In this case, the dead weight of the closure alone causes additional stress on the valve.

A critical factor for the above-mentioned vacuum valves is always the time required for safe opening and closing of the valve. This has a significant influence on process and machining times. The larger and more massive a closure element of a vacuum valve is, the greater the masses that have to be moved and the more time is required to move the closure element.

It is therefore an object of the present invention to provide a vacuum valve that provides improved closure and opening of the valve opening, particularly with respect to speed and reliability.

Another application of vacuum valves can be found, for example, in the field of transport systems. Pneumatic tube systems and vacuum transport systems should be mentioned here. Pneumatic tube transport is a form of fast and low-personnel transport of objects in small, cylindrical containers by means of e.g. compressed air or/and vacuum in tubes of constant caliber (typically up to approx. 20 cm).

A vacuum transport system as understood herein differs from a pneumatic tube system in particular in the size of the transported objects (significantly larger than 20 cm) and the lower internal pressure present in the tube system. Such systems are currently still in the development phase.

In general, these vacuum transport systems each propose a similar basic principle. In each case, it is a high-speed transport system in which capsules or other vehicles travel at very high speeds in a largely evacuated tube with a guidance system, e.g., on a rail system, an air cushion or magnetically repelled sliding. In the vicinity of stations, linear motors can enable high accelerations, as in a maglev train, while electrically powered compressors can generate sufficient propulsion when cruising speed is reached. Alternatively, a corresponding drive can be provided on the part of the object moving in the tube.

A vacuum transport system of this kind has, for example, reinforced concrete supports with two adjacently disposed travel tubes made of steel or another suitable material, e.g. metal-like, metal-containing or concrete-like material, in which at least a rough or fine vacuum prevails. The vacuum is intended to enable travel speeds of up to just above the speed of sound by reducing the air resistance within the transport tube. Capsules or vehicles with space for several passengers can be moved or loads transported in the tubes (e.g. cars).

The capsules or vehicles should be moved in a sliding manner with as little friction as possible. For this purpose, for example, the use of an electromagnetic levitation system is proposed.

For example, the capsules or vehicles can be made primarily of aluminum or alternative lightweight materials and have a diameter of at least two meters. Furthermore, an unladen weight of 3 to 3.5 metric tons is proposed, and a payload of between 12 and 25 metric tons may be provided.

The transport tubes can have an inner diameter of slightly more than the capsule diameter and a wall thickness of at least 20 mm. The internal pressure can be maintained at, for example, about 100 Pascal (1 millibar).

The support piers carrying the transport tubes may be positioned with an average spacing of about 30 meters and may be secured against earthquakes by damping elements. It is understood that the transport tubes can also be at least partially underground, for example analogous to a subway, etc., or designed as tunnels.

A problem for the operation of such a vacuum transport system is generally the creation and maintenance of a desired vacuum within the system. In particular, large losses of the internal vacuum can occur during unloading or loading or during removal or insertion of a transport vehicle into the transport tube.

A further problem is the fulfillment of safety requirements, in particular those imposed by the authorities, so that possible hazards can be avoided as far as possible during operation of the system. Particularly when transporting people, but also when transporting goods (e.g. hazardous goods), it is essential that the safety equipment provided enables people or goods to be recovered or evacuated from the transport tube unharmed in the event of an emergency.

It is therefore the object of the present invention to provide a separation device, in particular a vacuum valve, for a vacuum transport system, which reduces or avoids the above-mentioned disadvantages.

One particular object of the invention is to provide a vacuum valve which provides improved closing and opening of the transport system, especially with regard to speed and reliability.

The above-mentioned objects are solved by the realization of the characterizing features of the independent claims. Features which further form the invention in an alternative or advantageous manner are to be taken from the dependent claims.

The approach of the present invention to solve the above problems in the field of vacuum transport systems is based on an integration of a plurality of separation devices (valves) along the transport tube. On the one hand, the proposed separation devices can be used to atmospherically separate certain station areas along the line from the tube and make them ventilated and accessible for loading and unloading. After the loading activity, the area is then closed off again, evacuated and the valves opened.

On the other hand, the separation devices can be provided at certain regular intervals along the route. This allows a certain section of the transport tube to be closed in an emergency and then ventilated so that a rescue of people and/or goods can be initiated.

A vacuum valve according to the invention provides a reliable and robust seal for the transport tube when closed. In addition, reliable reproducibility of the sealing effect is ensured during multiple opening and closing processes.

The approach of the present invention to solving the above problems in the field of (classical) vacuum valves for vacuum processing processes is based on such a design of the valve that the closure can be closed and opened quickly and reliably.

The invention relates to a vacuum valve for (at least substantially) closing a first valve opening in a gas-tight manner, in particular for a vacuum transport system having a transport tube for transporting an object inside along the transport tube or for a vacuum processing process. The transport system may be constructed according to an approach described above.

The vacuum valve has a valve seat, which in turn has the first valve opening defining an opening axis and a first sealing surface. A closure element of the vacuum valve is provided for the substantially gas-tight closure of the first valve opening with a second sealing surface corresponding to the first sealing surface.

The components valve seat, valve opening and closure element can in particular be designed and dimensioned in such a way that the vacuum valve can be integrated into the vacuum transport system in terms of size and shape (diameter), in particular can be integrated in such a way that a transport tube diameter can be completely closed and completely released.

The valve opening thus corresponds in particular to a tube diameter or can be provided concentrically to the tube opening.

In particular, the first and/or the second sealing surface can have a sealing element (seal, sealing material). The sealing element is in particular vulcanized, glued or clamped.

The vacuum valve further comprises a drive unit for providing a movement of the closure element relative to the valve seat such that the closure element is adjustable from an open position, in which the closure element at least partially exposes the first valve opening, into a closed position, in which the closure element completely covers the first valve opening to provide a gas-tight closure of the first valve opening, and back.

The closure element is designed to be flexible in such a way that a spatial expansion of the closure element in the closed position is variable in a direction parallel to the opening axis as a function of an applied differential pressure.

In other words, the closure element can thus be curved, especially when a differential pressure is applied.

Due to the flexible design of the closure element, this element can be less massive and thus lighter. This means that a faster movement of the closure element can be provided.

In one embodiment of the vacuum valve according to the invention, the opening axis may be such that the first sealing surface faces in a direction parallel to the opening axis and the first sealing surface extends orthogonally to the opening axis.

In one embodiment, a first sealing plane may be defined by an extension of the first sealing surface and the opening axis may extend orthogonally to the first sealing plane.

According to one embodiment of the invention, a surface profile or a surface size of the closure element can be variable as a function of an applied differential pressure. For example, at very low or no differential pressure, the surface of the closure element can lie largely in a flat plane, whereas when the differential pressure is increased, the closure surface is curved and thus enlarged.

One embodiment of the vacuum valve according to the invention relates to an extension direction of the closure element, which in the open position may be different from an extension direction of the closure element in the closed position. For example, in the closed position the closure element extends substantially orthogonally to the opening axis, whereas in the open position the closure element extends largely parallel to the opening axis or in a rolled-up state extends along a roll-up axis. In particular, the roll-up axis can be orthogonal to the opening axis and orthogonal to the direction of extension of the closure element in the closed position.

In particular, the extension direction of the closure element can change in or during an adjustment from the open position to the closed position (or in the opposite direction).

In one embodiment, an orientation of the second, closure-side sealing surface may change upon movement from the open position to the closed position or from the closed position to the open position, in particular wherein the second sealing surface is substantially in a plane in the closed position and is curved or spiral (e.g., rolled up) in the open position.

The closure element can be designed so that it can be rolled up. For this purpose, the closure element can be designed as a type of curtain or segmented, for example.

The closure element can thus be curtain-like or designed in the manner of a roller shutter.

In one embodiment, the closure element may be segmented, wherein individual segments of the closure element are rigid and adjacent segments are connected by means of a flexible connection, e.g. by means of a cable pull or by means of respective intermediate membranes (e.g. connected to the segments in a gas-tight manner), and/or wherein the adjacent segments have a sealing element, in particular one sealing element each.

The flexible connection can provide mobility of the entire closure element. In particular, if the flexible connection is designed as a pull rope and connects the segments, the closure element can be brought into a defined position with respect to the valve opening, e.g. by rolling up or unrolling the pull rope, e.g. laterally guided in a rail.

In one embodiment, the closure element comprises or is made of a textile-based and/or fabric-like material. Such a material may be, for example, a metallic fabric, a metallic knit, or other textile (e.g., containing aramid fibers).

As a textile-based and/or fabric-like material, a textile raw material (e.g. natural fibers, man-made fibers) and a non-textile raw material are also included here. These raw materials can be processed into linear, planar and spatial structures and in this form thus at least partially embody the closure element.

The textile-based and/or fabric-like material can provide, in particular, a robustness and resistance of the closure element required for use in a vacuum transport system.

For example, this material can absorb and dissipate forces acting on the closure element due to an applied differential pressure.

In one embodiment, the closure element comprises a flexible and gas-tight shut-off component. The shut-off component may, for example, comprise a film-like, rubber-like or membrane-like material. In particular, the shut-off component can be designed as a gas-tight mat or metallic sealing foil.

In one embodiment, the closure element comprises a laminate. The laminate may be, for example, a combination of the textile-based and/or fabric-like material and the closure component.

According to a further embodiment, the vacuum valve may comprise a further valve seat and the further valve seat may in turn comprise a second valve opening and a third sealing surface surrounding the second valve opening, wherein the second valve opening is opposite the first valve opening and an opening axis defined by the second valve opening extends coaxially or parallel to the opening axis of the first valve opening.

The further valve seat is arranged opposite the valve seat, and the closure element is configured for substantially gas-tight closure of the second valve opening and has a fourth sealing surface corresponding to the third sealing surface, wherein the fourth sealing surface faces in an opposite direction relative to the second sealing surface.

According to a further embodiment, the valve seat of the vacuum valve can have two sealing surfaces, in particular the first and third sealing surfaces. In particular, the sealing surfaces are arranged opposite each other.

In contrast to the previously described embodiment, the vacuum valve here has one valve seat instead of two valve seats. Both variants with two sealing surfaces on the seat side provide a sealing capability on both sides of the transport tube or of two valve openings at least partially delimited by the sealing surfaces.

This can be particularly advantageous if the valve is used as an emergency system for shutting off a tunnel section. Here, the side of the valve on which such an emergency occurs remains undetermined. Thus, the system must preferably provide the possibility of sealing both sides.

In one embodiment, the vacuum valve may comprise an actuator and the actuator may be coupled to the valve seat and/or to the first sealing surface such that the actuator provides a controlled mobility of the first sealing surface in a direction parallel to the opening axis. The actuator can, for example, be designed as an electric motor or be pneumatically or hydraulically operated.

In particular, the vacuum valve may comprise a control unit and the control unit can be set up to control at least the actuator in such a way that, when the closure element is in the closed position, in particular after a movement of the closure element from the open position into the closed position, the first sealing surface is moved in the direction of the closure element and is pressed in the direction of the second sealing surface.

According to one embodiment, the first and/or the second sealing surface may comprise a sealing material and a gas-tight closure of the valve opening may be provided by contacting the sealing material through the first and the second sealing surface.

In one embodiment of the vacuum valve according to the invention, the first sealing surface at least partially, in particular completely, surrounds the first valve opening.

A combination or overlay of multiple sealing surfaces may be provided to provide a complete seal of the valve opening. For example, one sealing surface may be provided for lateral sealing and another sealing surface for lower sealing.

In one embodiment, the closure element may comprise an expansion element whose volume and/or surface area is variable as a function of an internal pressure present in the expansion element. The expansion element has the second sealing surface.

In particular, the expansion element can be made to surround the first valve opening in the closed position and the second sealing surface can be brought, in particular pressed, into contact with the first sealing surface by increasing the internal pressure.

The expansion element can be tubular or designed as a hose.

The expansion element can thus provide a seal to the valve opening by pressurizing the interior of the expansion element. An increase in the internal pressure leads to an expansion or increasing expansion of the volume or surface of the expansion element. Due to the expansion, the second sealing surface in the closed position reaches the first sealing surface of the valve seat, wherein a seal of the valve opening can be provided by means of an intermediate seal.

In particular, the expansion element can be pushed or pulled against a surface or edge of the valve seat (due to a force applied to the expansion element by a differential pressure), thereby providing a seal to the valve opening.

The invention further relates to a vacuum transport system comprising a transport tube for transporting an object inside along the transport tube, wherein a negative pressure, in particular a vacuum, can be provided inside the transport tube relative to the surrounding atmosphere. The vacuum transport system further comprises a vacuum valve according to the invention as described herein, integrated into the vacuum transport system and connected to the transport tube. The valve seat provides the first valve opening and the first sealing surface inside the vacuum transport system. The first valve opening substantially corresponds to a tube cross-section.

The drive unit can be used to provide a controlled movement of the closure element from the open position to the closed position and back. By means of the vacuum valve, an inner volume of the vacuum transport system can be closed, in particular separated, as a whole or in segments, and can be opened.

The object movable in the transport tube can be a means of transport, in particular a capsule or a vehicle, wherein the means of transport is designed for transporting a person and/or goods.

The vacuum transport system can accordingly have a tube diameter of several meters, in particular at least two meters. The vacuum transport system can be designed by integrating the vacuum valve with an emergency system for closing off a tunnel section or have a hatch device for introducing and removing objects into and from the transport system.

The invention is not limited to use in a vacuum transport system. Rather, a vacuum valve according to the invention can be used, for example, as a transfer valve or as a pump valve. In general, the use of the vacuum valve according to the invention is conceivable for all vacuum-related fields of application, in particular for the field of semiconductor manufacturing or other applications in connection with a vacuum process chamber.

The devices according to the invention are described in more detail below by means of concrete exemplary embodiments shown schematically in the drawings, purely by way of example, and further advantages of the invention are also discussed. The figures show in detail:

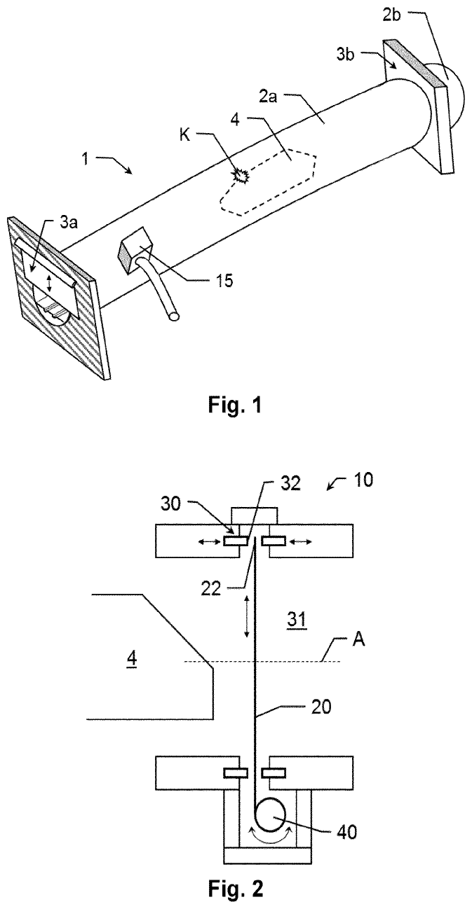

FIG. 1 shows an embodiment of a vacuum transport system with a vacuum valve for closing or disconnecting a transport tube of the vacuum transport system;

FIG. 2 shows an embodiment of a vacuum valve according to the invention for closing an opening or sealing a volume;

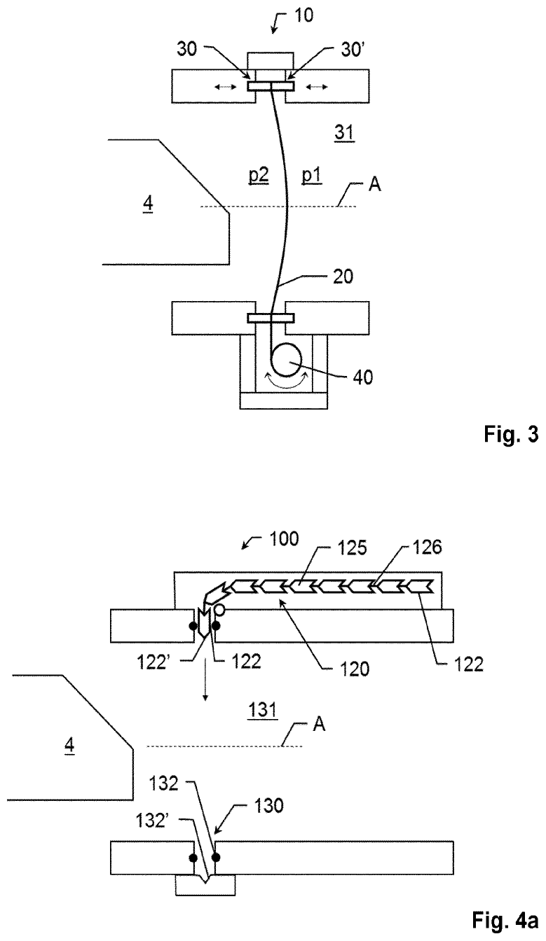

FIG. 3 shows an embodiment of a vacuum valve according to the invention for closing an opening or sealing a volume in the closed state;

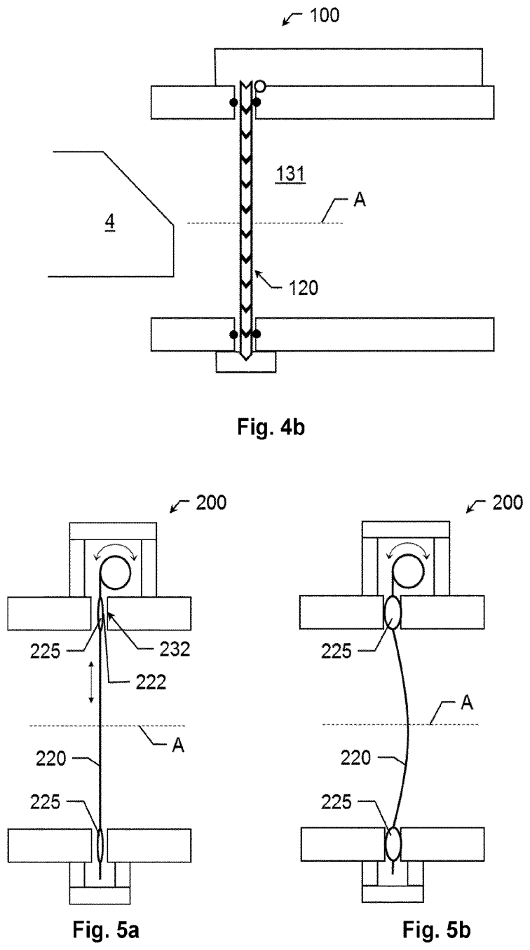

FIGS. 4a-b show a further embodiment of a vacuum valve according to the invention for closing an opening or sealing a volume;

FIGS. 5a-b show a further embodiment of a vacuum valve according to the invention for closing an opening or sealing a volume; and

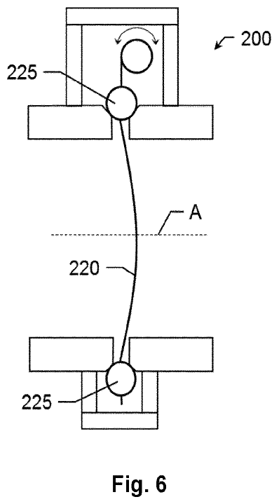

FIG. 6 shows a further embodiment of a vacuum valve according to the invention for closing an opening or sealing a volume.

FIG. 1 schematically shows a section of an exemplary transport tube 1 of a vacuum transport system. The tube 1 is preferably composed of a plurality of tube segments (see 2a and 2b) which can be shut off from one another by vacuum valves (see 3a and 3b).

Flooding with air or equalizing pressure with the environment is relevant for safety reasons. For example, a vehicle 4 moving inside the transport tube 1 could experience a complication K such as a medical emergency, a leak in the vehicle housing, or a fire. In such an emergency situation, it is desired that the vehicle 4 stop as soon as possible. If the situation permits, the vehicle 4 could stop in a defined transport tube segment, or in any segment, in which case sensors are preferably present to detect the vehicle 4.

If the vehicle 4 comes to a stop in such a way that a valve cannot close, the next available valve can advantageously be accessed. Otherwise, a device could also be provided that moves the vehicle 4 in such a way that the valve area becomes free and the valve can close.

The vehicle 4 may be, for example, a capsule or a vehicle and may be configured to transport at least one person and/or goods.

The transport system also has a controller (not shown), in particular a computer, which can control two adjacent ones of the vacuum valves 3a and 3b in such a way that they close or open an inner volume of the intermediate transport tube segment 2a. A provided ventilation device 15 can then (after closing the segment 2a) be controlled, e.g. likewise by the controller, in order to cancel by ventilation a vacuum or prevailing negative pressure prevailing in the inner volume of the intermediate transport tube segment 2a.

In particular, an unloading/reloading hatch is provided in some or all of the tube segments, for example, for a removal or insertion of the vehicle 4 (not shown).

For a vacuum transport system, especially for a transport of persons, a critical factor when an emergency occurs is the duration needed to close a transport tube segment 2a. According to the invention, a vacuum valve for closing the transport tube is proposed, with which the operation of closing or opening can be performed relatively very quickly and reliably.

FIG. 2 shows a vacuum valve 10 according to the invention with a valve seat 30 and a closure element 20. A valve opening 31 and an opening axis A are defined by the valve seat 30. A first sealing surface 32 surrounds the valve opening 31, and the closure element 20 has a second sealing surface 22 corresponding to the first sealing surface 32. A drive unit 40 is provided for moving the closure element 20.

The closure element 20 is designed to be of flexible configuration in such a way that a spatial extension of the closure element 20 in the closed position, in particular in a closed valve state, in a direction parallel to the opening axis A is variable as a function of an applied differential pressure.

FIG. 3 shows an example of the flexibility of the closure element 20 according to the invention. The valve 10 is closed here. The first and second sealing surfaces are in contact by pressing the valve seat 30 against the closure element 20. For such contacting or pressing, the valve seat 30 may be designed to be movable in the direction towards the closure element 20.

In the embodiment shown, the valve 10 has two valve seats 30, 30′, which are arranged on both sides of the closure element 20 and are movable. Sealing is effected here by means of mutual compression of the two valve seats, with part of the closure element, in particular its sealing surface 22, being present between the valve seats. In particular, the closure element 20 here has two opposite sealing surfaces corresponding to the valve seats. However, it is understood that an embodiment with a one-sided pressing (not shown) is also to be understood as an embodiment according to the invention.

Different pressures p1 and p2 are present in the tube segments separated from each other by the closed valve 10. As a result, a differential pressure (Δp) is applied to the valve closure 20. In this case, the pressure p1 is lower (e.g. vacuum) than the pressure p2 in the tube segment in which the vehicle 4 is located. Such a case can occur, for example, if the segment with the vehicle 4 is ventilated, for example, for recovery purposes. Due to the applied differential pressure, the closure element 20 is changed with respect to its spatial extension, deflection or curvature. In other words, the valve closure element 20 undergoes a change in its surface course due to the applied differential pressure.

The closure element 20 may comprise a flexible or elastic textile or fabric and/or a gas-tight barrier component, such as a membrane or film-like layer. In particular, the closure element 20 may be designed as a multi-layer arrangement of corresponding materials or as such a layer composite.

The closure element 20 may include at least one mechanically robust, durable material reinforced with or containing, for example, metal, fiberglass, carbon fiber, Kevlar, or aramid fiber. In particular, this material component provides a desired resistance to force or pressure application.

The closure element 20 may comprise at least one thermally stable and/or diffusion-resistant and/or gas-tight, in particular polymer-containing, material.

The closure element 20 may be provided, for example, as a layered combination or composite of a mechanically robust material and a sealing material.

The valve 10 has a guide for guiding the closure element 20. The guide can, for example, have a pulling device by means of which the closure element 20 can be pulled through the transport tube transversely to the opening.

In the open position, the closure element 20 may be kept rolled up (as shown) or parked.

In an alternative embodiment (not shown), the closure element can be moved and parked by means of two rollers. The rollers are arranged at opposite areas of the tunnel wall. The closure element can be unrolled from the first roller while being rolled onto the second roller. The closure element, e.g. a cloth or a tarpaulin, can enclose an area of at least twice the tube diameter when fully unrolled.

A first portion of the closure element may have a continuous closed surface for closing the valve opening. A second portion of the closure element may have an opening shaped and sized to match the diameter of the tube.

In the open position, the second section corresponds to the valve opening and releases the opening. In the closed position, the first section corresponds to the valve opening and provides closability of the opening.

Such a design allows the tarp to be quickly pulled through the transport tube to close the opening. This embodiment can provide a reduction in any turbulence or swirl that may occur during closing or opening due to the comparatively small structural changes inside the tube to close the opening.

The valve seat or the two valve seats can be annular and designed to provide a sealing stroke. In particular, an actuator coupled to the valve seat or integrated in the valve seat can be provided for this purpose.

The comparatively low weight of the closure element 20 means that it can be moved and closed correspondingly quickly due to its small mass. This is particularly advantageous when an emergency situation occurs in or on the vacuum transport system.

The occurrence of a corresponding emergency, i.e., for example, the occurrence of a leak at the tube or the failure of the electrical supply and thus the failure of the drive system, cannot, by its very nature, be predicted. In particular, the location of such an emergency cannot be predetermined. Thus, such an event can occur on either side of an obstructed closure component 20. This in turn requires the possibility of being able to establish a seal of the tube against both sides. This can be ensured by the sealing on both sides shown.

To close the vacuum valve 10, the closure 20 is first moved in such a way that the valve opening is covered. This movement can be provided by means of the drive unit 40 and/or the guide. In this overlapping position, there is still no contact between a closure sealing surface and a corresponding valve seat sealing surface.

Subsequent active transverse movement of at least one valve seat in the direction of the closure element 20 can then provide the sealing. To provide the transverse movement, plungers or punches can be provided, for example, which are mechanically driven and move the valve seat and/or at least the first sealing surface.

In the embodiment shown in FIGS. 2 and 3, a closing movement from bottom to top is provided. However, it is understood that the movement can also occur in the opposite direction or in the horizontal direction.

In particular, the valve closure 20 has a circumferential sealing surface 22 with a seal (sealing material). Correspondingly, the valve seat 30 has a corresponding sealing surface.

Due to the comparatively slim design of the closure 20 which is caused by the embodiment, i.e. having little mass and thus thin wall thickness in the direction of the opening axis, the sealing of the opening 31 can take place in a provided interruption in a guide system (e.g. rail) for the vehicle 4. According to the embodiment, the dimension (width) of this guide system interruption can be comparatively small and thus can be integrated into the transport system without noticeable disadvantages. By providing such an interruption, the integration of the valve into the transport system can be realized comparatively easily. Also, this brings the advantage that for closing the tube, parts of the guide system do not first have to be removed from a valve area in a first step so that sufficient contacting and thus sealing of the sealing surfaces can be achieved, but that the closure element 20 can be pulled directly through the tube without preceding steps and the gas-tight shut-off of the tube can be provided. As a result, the sealing can be carried out significantly faster and more reliably than with previously known solutions.

FIGS. 4a and 4b show another embodiment of a vacuum valve 100 according to the invention.

The vacuum valve 100 comprises a closure element 120 and a valve seat 130. In this valve embodiment, the valve seat 130 may comprise a sealing surface 132 and/or a sealing surface 132′ as a first sealing surface.

Correspondingly, the second sealing surface of the closure 120 corresponding to this first sealing surface may be designed as a sealing surface 122 oriented parallel to the opening axis A and/or as a sealing surface 122′ oriented transverse to the opening axis A.

When sealing surfaces 122 and 132 are provided, these sealing surfaces preferably surround the valve opening 131, in particular in the closed position.

The flexibility of the spatial extension or the spatial surface profile of the closure element 120 is provided here by a segmented structure. The individual segments 125 are interconnected, i.e. respectively adjacent segments are coupled by means of respective intervening connecting elements 126.

The segments 125 are designed to be mechanically robust and rigid in particular, and thus each in itself represents a gas-tight barrier. The connecting elements 126 can also be made of a suitable, in particular elastic, sealing material, e.g. foil, laminate or membrane. The segments 125 and the connecting elements 126 may in particular be mounted so as to be rotatable or tiltable relative to one another. In this connection, the connecting elements 126 can be made of metal, in particular in the form of a chain.

In one embodiment, the segments 125 and the connecting elements 126 are connected to each other in such a way that the closure element as a whole (also in the open position) embodies a gas-tight valve closure. The transitions between the respective segments 12 and the connecting elements 126 are already gas-tight.

In particular, the segmentation of the closure element 120 may be of a roller shutter type, for example similar to a roller garage door or a roller shutter. The segmentation may provide a comparatively compact design. The valve closure 120 requires little installation space, in particular in the open position or park position (FIG. 4a).

In particular, the segments 125 are guided by a rail and/or connected to a cable pull, which may be formed by the connecting elements 126.

FIG. 4b shows the valve closure 120 in a closed position. The individual segments 125 are brought together in this case. The valve opening 131 is closed in a gas-tight manner by pressing together adjacent segments in each case and contacting the first sealing surfaces on the closure side with the second sealing surface on the seat side.

The figure shows a contacting of the sealing surfaces provided to the right of the closure 120. With a lower internal pressure present in the right tube segment than in the left tube segment, such contacting of the closure 120 can occur passively due to the pressure difference, i.e. the closure 120 is pressed onto the sealing surface 132.

It is understood that the closure element 120 alternatively or additionally has a corresponding sealing surface on its left side, which corresponds to a likewise corresponding sealing surface on the part of the valve seat in the closed position. In this way, sealing can also be provided in the case of opposite differential pressure.

In particular, the sealing surfaces on the valve seat side can be movably mounted and pressed onto the closure element 120 by means of a motor, pneumatically or hydraulically to provide a seal. Alternatively or additionally, the closure element 120 may be movable along the opening axis A and pressed onto a valve seat side seal to provide sealing.

In one embodiment, the closure element 120 may be sealed with respect to the guide for the closure element 120. In this regard, a guide rail may include the first sealing surface.

A partial sealing of the opening 131 can also be provided by the contact of the sealing surfaces 122′ and 132′. The lower, free end of the closure element 120 is pressed onto a stop corresponding in shape and size.

Providing a two-dimensional gas-tightness of the closure element 120 can be achieved by individual sealing surfaces at the respective front sides and rear sides (in the direction of movement during a closing movement) of the individual segments 125. By pressing the segments 125 and thus their sealing surfaces together as shown in FIG. 4b, a closure is then created which completely covers the valve opening 131 in a gas-tight manner, comparable to a continuous closure wall.

FIGS. 5a and 5b show another embodiment of a vacuum valve 200 according to the invention.

The vacuum valve 200 has a closure element 220 and a valve seat. In this valve embodiment, the valve seat has a first sealing surface 232. A second sealing surface 222 of the closure 220 corresponding to this first sealing surface 232 is associated with an expansion element 225 of the closure element 220. In FIGS. 5a and 5b, the sealing surfaces are respectively designated on the right side of the closure element 220. However, it is understood that corresponding sealing surfaces (and valve seat) may also be provided on the left side of the closure 220, thereby providing a bilateral seal.

The expansion element 225 is designed and arranged in such a way that a sealing of the valve opening can be provided by means of expansion of the expansion element 225. For this purpose, the closure element 220 can be moved to the closed position, wherein the expansion element 225 is expanded after reaching the closed position.

For example, the expansion element 225 is designed as a tubular or pocket-like component, particularly a hose. In particular, the expansion element 225 may be configured so that it surrounds the valve opening in the closed position. In particular, the expansion element 225 may comprise or be made of an elastic material.

In the closed position, the expansion element 225 is in an opposing position to the valve seat. FIG. 5a shows this state, which exists in particular after reaching the closed position (starting from the open position) or after a contraction of the expansion element 225. The valve 200 is not tightly closed in this case.

To close the valve 200, in particular the valve opening, the expansion element 225 may be expanded. Such expansion or expanding can be carried out, for example, by inflating the expansion element 225. For this purpose, the inner volume of the expansion element 225 is filled, for example, with air (compressed air) or another fluid (gas, liquid, etc.), the fluid is in particular pumped or blown into the inner volume of the expansion element 225.

The expansion of the expansion element 225 can press the sealing surface 222 on the closure side against the sealing surface 232 on the seat side (FIG. 5b), resulting in a gas-tight shut-off of the opening. In this case, the valve seat is designed in particular so that the expansion element 225 can compress in a space or gap provided for this purpose.

FIG. 5b shows a condition in which different pressures are present in areas separated from each other by the closed valve 200. As a result, a differential pressure (Δp) is applied to the valve closure 220. The differential pressure applied causes the closure element 220 to bulge in the direction of the area with lower relative pressure.

To open the valve 200, the expansion element 225 can be vented or the fluid can be pumped out of the inner volume. This releases the compression and a contact of the sealing surfaces 222 and 232 can be dissolved. Subsequently, the sealing element 220 can be rolled up, for example.

FIG. 6 shows a variant of the vacuum valve 200 according to FIG. 5b in accordance with the invention in the closed state. The closure element 220 here also has an expansion element 225. In contrast to the embodiment according to FIGS. 5a and 5b, the expansion element 225 is not located directly in a space or gap provided for this purpose when the valve is closed, but is pressed against an (outer) edge or surface provided for this purpose.

The valve seat may be beveled for this purpose as shown, providing a sealing surface cooperating with the expansion element 225 (e.g., balloon or tube). Alternatively, the valve seat may have a corner or edge that contacts the expansion element 225. In general, any surface of the valve seat which sealingly cooperates with the expansion element 225 during closing of the valve and/or is provided for this purpose can be understood as corresponding sealing surface.

An advantage of this embodiment is that the expansion element 225 is pressed by this arrangement in the event of an applied differential pressure due to this differential pressure and the resulting curvature of the closure element 220, in particular additionally, onto the seat-side sealing surface. The greater the differential pressure, the greater the force pulling on the expansion element 225 and thus the pressing force between the sealing surfaces (between expansion element 225 and valve seat).

It is understood that the figures shown are only schematic illustrations of possible exemplary embodiments. According to the invention, the various approaches can also be combined with each other and with valves for closing transport systems of the prior art.

1. A vacuum valve for gas-tight closure of a first valve opening, for a vacuum transport system having a transport tube for transporting an object inside along the transport tube, comprising
a valve seat having the first valve opening defining an opening axis and a first sealing surface,
a closure element for the substantially gas-tight closure of the first valve opening with a second sealing surface corresponding to the first sealing surface, and
a drive unit for providing a movement of the closure element relative to the valve seat such that the closure element is adjustable from an open position, in which the closure element at least partially exposes the first valve opening, into a closed position, in which the closure element completely covers the first valve opening, and back again,
wherein
the closure element is designed to be flexible in such a way that a spatial expansion of the closure element in the closed position is variable in a direction parallel to the opening axis as a function of an applied differential pressure.

2. The vacuum valve according to claim 1, wherein the opening axis is such that the first sealing surface faces in a direction parallel to the opening axis and the first sealing surface extends orthogonally to the opening axis.

3. The vacuum valve according to claim 1, wherein a first sealing plane is defined by an extension of the first sealing surface and the opening axis extends orthogonally to the first sealing plane.

4. The vacuum valve according to claim 1, wherein a surface profile or a surface size of the closure element is variable as a function of an applied differential pressure.

5. The vacuum valve according to claim 1, wherein an extension direction of the closure element in the open position is different from an extension direction of the closure element in the closed position.

6. The vacuum valve according to claim 1, wherein the extension direction of the closure element changes during an adjustment from the open position to the closed position.

7. The vacuum valve according to claim 1, wherein an orientation of the second sealing surface changes upon movement from the open position to the closed position or from the closed position to the open position, wherein the second sealing surface is substantially in a plane in the closed position and is curved or spiral in the open position.

8. The vacuum valve according to claim 1, wherein the closure element is designed to be rolled up.

9. The vacuum valve according to claim 1, wherein the closure element is curtain-like or designed in the manner of roller shutter.

10. The vacuum valve according to claim 1, wherein the closure element is segmented, wherein individual segments of the closure element are rigid and adjacent segments are connected by means of a flexible connection and/or have a sealing element, one sealing element each.

11. The vacuum valve according to claim 1, wherein the closure element comprises a textile-based and/or fabric-like material.

12. The vacuum valve according to claim 1, wherein the closure element comprises a flexible and gas-tight shut-off component.

13. The vacuum valve according to claim 1, wherein
the vacuum valve comprises a further valve seat and the further valve seat comprises a second valve opening and a third sealing surface surrounding the second valve opening, wherein the second valve opening is opposite the first valve opening and an opening axis defined by the second valve opening extends coaxially or parallel to the opening axis of the first valve opening,
the further valve seat is arranged opposite to the valve seat and
the closure element is configured for substantially gas-tight closure of the second valve opening and has a fourth sealing surface corresponding to the third sealing surface, wherein the fourth sealing surface faces in an opposite direction relative to the second sealing surface.

14. The vacuum valve according to claim 1, wherein the vacuum valve comprises an actuator and the actuator is coupled to the valve seat and/or to the first sealing surface such that the actuator provides a controlled mobility of the first sealing surface in a direction parallel to the opening axis.

15. The vacuum valve according to claim 1, wherein that the vacuum valve comprises a control unit and the control unit is set up to control at least the actuator in such a way that, when the closure element is in the closed position, the first sealing surface is moved in the direction of the closure element and is pressed in the direction of the second sealing surface.

16. The vacuum valve according to claim 1, wherein the first and/or the second sealing surface comprises a sealing material and a gas-tight closure of the valve opening may be provided by means of contacting the sealing material through the first and the second sealing surface.

17. The vacuum valve according to claim 1, wherein the first sealing surface surrounds the first valve opening.

18. The vacuum valve according to claim 1, wherein the closure element comprises an expansion element whose volume and/or surface area is variable as a function of an internal pressure present in the expansion element, wherein the expansion element comprises the second sealing surface.

19. The vacuum valve according to claim 18, wherein the expansion element in the closed position surrounds the first valve opening and the second sealing surface can be brought into contact with the first sealing surface Ga) by increasing the internal pressure.

20. The vacuum valve according to claim 18, wherein the expansion element is tubular or designed as a hose.

21. A vacuum transport system, comprising
a transport tube for transporting an object inside along the transport tube, wherein a negative pressure can be provided inside the transport tube relative to the surrounding atmosphere, and
a vacuum valve integrated in the vacuum transport system and connected to the transport tube,
wherein
a valve seat provides first valve opening and a first sealing surface inside the vacuum transport system,
the first valve opening substantially corresponds to a tube cross-section,
a controlled movement of a closure element into an open position and a closed position can be provided by means of a drive unit, and
by means of the vacuum valve, an inner volume of the vacuum transport system can be closed, as a whole or in segments, and can be opened.

22. The vacuum transport system according to claim 21, wherein the object is a means of transport, wherein the means of transport is designed for transporting a person and/or goods.
